(19) United States
(12) Patent Application Publication
(10) Pub. No.: US 2017/0306540 A1
(43) Pub. Date: Oct. 26, 2017

(54) Coform Nonwoven Web Containing Expandable Beads

(71) Applicant: Kimberly-Clark Worldwide, Inc., Neenah, WI (US)

(72) Inventor: Simon K. Poruthoor, Alpharetta, GA (US)

(73) Assignee: Kimberly-Clark Worldwide, Inc., Neenah, WI (US)

(21) Appl. No.: 15/517,536

(22) PCT Filed: Nov. 25, 2014
(86) PCT No.: PCT/US2014/067317

§ 371 Date: Apr. 7, 2017

(51) Int. Cl. D04H 3/16; D04H 3/007; B01J 20/28; D04H 3/045; A47L 13/16

(52) U.S. Cl. CPC D04H 3/16; D04H 3/045; A47L 13/16; B01J 20/28028; D04H 3/007

(57) ABSTRACT

A coform nonwoven web that contains a composite matrix formed from a combination of synthetic fibers and an absorbent material is provided. A plurality of thermally expandable beads are also contained within the composite matrix. By selectively controlling various aspects of the thermal activation of the beads, as well as the particular manner in which the beads are incorporated within the nonwoven web, the present inventors have discovered that the resulting coform web can achieve an increased bulk that remains relatively stable even in a wet condition. Thus, the resulting coform web can be readily employed in a wet wipe without losing its bulk and overall texture.

### BACKGROUND OF THE INVENTION

Nonwoven webs that contain an absorbent material (e.g., pulp fibers) are often used as an absorbent layer in a wide variety of applications, including wet wipes. A common problem with many conventional nonwoven materials is that they lack enough bulk or thickness to enable a user to easily handle and manipulate the web during wiping or cleaning. This becomes particularly problematic when the substrate is wet as most absorbent materials tend to become more compressed in this state. One solution to this problem has been to simply add more material to the nonwoven web so that the desired bulk is achieved. Unfortunately, this can result in a significant increase in the material and transportation cost of the substrate. As such, a need currently exists for an improved nonwoven web for use in a variety of applications.

### SUMMARY OF THE INVENTION

In accordance with one embodiment of the present invention, a coform nonwoven web is disclosed that comprises a composite matrix formed from a combination of synthetic fibers and an absorbent material. A plurality of beads are contained within the composite matrix that include a propellant encapsulated within a hollow thermoplastic polymer shell. In another embodiment, a wipe may be formed that comprises the coform nonwoven web. If desired, the wipe may be a wet wipe that, for instance, contains from about 150 to about 600 wt. % of a liquid solution based on the dry weight of the wipe.

In accordance with yet another embodiment of the present invention, a method for forming a wipe is disclosed. The method comprises providing a coform nonwoven web comprising a composite matrix formed from a combination of synthetic fibers and an absorbent material, wherein a plurality of expandable beads are contained within the composite matrix that contain a propellant. The beads are expanded by heating the web to a temperature above the boiling point of the propellant.

Other features and aspects of the present invention are described in more detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a schematic illustration one embodiment of a method for forming the coform web of the present invention;

FIG. 2 is an illustration of certain features of the apparatus shown in FIG. 1;

FIG. 3 is a cross-sectional view of one embodiment of a coform nonwoven web formed according to the present invention;

FIG. 4 is a schematic illustration of another embodiment for incorporating beads into coform nonwoven web; and

FIG. 5 is a schematic illustration of yet another embodiment for incorporating beads into coform nonwoven web.

Repeat use of reference characters in the present specification and drawings is intended to represent same or analogous features or elements of the invention.

### DETAILED DESCRIPTION OF REPRESENTATIVE EMBODIMENTS

### Definitions

As used herein the term “nonwoven web” generally refers to a web having a structure of individual fibers or threads which are interlaid, but not in an identifiable manner as in a knitted fabric. Examples of suitable nonwoven fabrics or webs include, but are not limited to, meltblown webs, spunbond webs, bonded carded webs, airlaid webs, coform webs, hydraulically entangled webs, and so forth.

As used herein, the term “meltblown web” generally refers to a nonwoven web that is formed by a process in which a molten thermoplastic material is extruded through a plurality of fine, usually circular, die capillaries as molten fibers into converging high velocity gas (e.g., air) streams that attenuate the fibers of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin, et al. Generally speaking, meltblown fibers may be microfibers that are substantially continuous or discontinuous, generally smaller than 10 micrometers in diameter, and generally tacky when deposited onto a collecting surface.

As used herein, the term “spunbond web” generally refers to a web containing small diameter substantially continuous fibers. The fibers are formed by extruding a molten thermoplastic material from a plurality of fine, usually circular, capillaries of a spinneret with the diameter of the extruded fibers then being rapidly reduced as by, for example, eductive drawing and/or other well-known spunbonding mechanisms. The production of spunbond webs is described and illustrated, for example, in U.S. Pat. No. 4,340,563 to Appel, et al., U.S. Pat. No. 3,692,618 to Dorschner, et al., U.S. Pat. No. 3,802,817 to Matsuki, et al., U.S. Pat. No. 3,338,992 to Kinney, U.S. Pat. No. 3,341,394 to Kinney, U.S. Pat. No. 3,502,763 to Hartman, U.S. Pat. No. 3,502,538 to Levy, U.S. Pat. No. 3,542,615 to Dobo, et al., and U.S. Pat. No. 5,382,400 to Pike, et al. Spunbond fibers are generally not tacky when they are deposited onto a collecting surface. Spunbond fibers may sometimes have diameters less than about 40 micrometers, and are often between about 5 to about 20 micrometers.

### DETAILED DESCRIPTION

Reference now will be made in detail to various embodiments of the invention, one or more examples of which are set forth below. Each example is provided by way of explanation, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention cover such modifications and variations.

Generally speaking, the present invention is directed to a coform nonwoven web that contains a composite matrix formed from a combination of synthetic fibers and an absorbent material. A plurality of expandable beads are also contained within the composite matrix. The beads may be formed from a hollow thermoplastic polymer shell within which a propellant is encapsulated. The propellant may be in the form of a liquid having a boiling temperature that is less than the softening temperature of the thermoplastic polymer shell. The boiling point at atmospheric pressure may, for instance, range from about −50° C. to about 100° C., in some embodiments from about −20° C. to about 50° C., and in some embodiments, from about −20° C. to about 30° C. The beads can thus be expanded by heating to a temperature above the boiling temperature of the liquid so that it begins to evaporate and exert an increased pressure on the inner walls of the polymer shell. Heating can occur, for instance, at a temperature of from about 30° C. to about 230° C., in some embodiments from about 60° C. to about 220° C., and in some embodiments, from about 100° C. to about 200° C. Because heating also tends to soften the shell, the increased pressure on the shell walls can result in a significant expansion of the beads. After thermal activation, for instance, the beads can be expanded to a size (e.g., diameter or length) that is at least about 10 times, in some embodiments at least about 20 times, and in some embodiments, from about 30 to about 200 greater than their initial size. Thus, the volume-average size (e.g., diameter) of the beads after expansion may be from about 0.5 to about 30 millimeters, in some embodiments from about 2 to about 10 millimeters, and in some embodiments, from about 3 to about 6 millimeters. Prior to expansion, however, the average size of the expandable beads may only be from about 0.1 to about 5 millimeters, in some embodiments from about 0.2 to about 3 millimeters, and in some embodiments, from about 0.3 to about 2 millimeters.

By selectively controlling various aspects of the thermal activation of the beads, as well as the particular manner in which the beads are incorporated within the nonwoven web, the present inventors have discovered that the resulting coform web can achieve an increased bulk that remains relatively stable even in a wet condition. Thus, the resulting coform web can be readily employed in a wet wipe without losing its thickness and overall texture. For instance, after expansion of the beads, the ratio of the caliper of the web when applied with a wet wipe solution to the caliper of the web in a dry state may, for instance, be about 0.5 or more, in some embodiments from about 0.7 to about 1.0, and in some embodiments, from about 0.8 to about 1.0. The caliper (or thickness) of the web may, for instance, be about 0.1 centimeters or more, in some embodiments from about 0.2 to about 3 centimeters, and in some embodiments from about 0.4 to about 2 centimeters in a dry and/or wet state. The bulk of the coform nonwoven web may likewise be about 10 cubic centimeters per gram (“cm³/g”) or more, in some embodiments from about 12 to about 180 cm³/g, and in some embodiments from about 15 to about 100 cm³/g in a dry state. Such a high bulk and caliper can result in a web that is relatively easy to handle during wiping or cleaning, but yet relatively inexpensive as the use of additional material is not necessarily required to achieve the desired properties.

Various embodiments of the present invention will now be described in more detail.

### I. Expandable Beads

As noted above, the beads employed in the coform nonwoven web may include a propellant contained within a hollow thermoplastic polymer shell. The thermoplastic polymer used to form the shell is generally obtained by polymerizing one or more ethylenically unsaturated monomers. Examples of suitable monomers may include, for instance, styrenes (e.g., styrene, halogenated styrene, α-methyl styrene, etc.); olefins (e.g., ethylene, propylene, etc.); nitriles (e.g., acrylonitrile, methacrylonitrile, α-chloroacrylonitrile, α-ethoxyacrylonitrile, fumaronitrile, crotonitrile, etc.); acrylic esters (e.g., methyl acrylate, ethyl acrylate, etc.); methacrylic esters (e.g., methyl methacrylate, isobornyl methacrylate, ethyl methacrylate, etc.); vinyl halides (e.g., vinyl chloride); vinyl esters (e.g., vinyl acetate; vinylidene halides (e.g., vinylidene chloride); dienes (e.g., butadiene, isoprene chloroprene etc.); and so forth, as well as mixtures thereof. In one embodiment, for example, the bead shell may be formed from polystyrene, such as those available from BASF under the trade designation STYROPOR®. In another embodiment, the bead shell may be formed from a copolymer of methylmethacrylate and acrylonitrile repeating units, optionally in combination with a vinylidene dichloride repeating unit. Such copolymer-based beads are available from Akzo Nobel under the trade designation EXPANCEL®.

The propellant may be incorporated into the beads in a variety of different ways. In some embodiments, for instance, the monomers used to form the shell may simply be polymerized in the presence of the propellant. In other embodiments, the propellant may be impregnated into the polymer shell after it is formed. Regardless, examples of some suitable propellants may include hydrocarbons (e.g., propane, n-pentane, isopentane, neopentane, butane, isobutane, hexane, isohexane, neohexane, heptane, isoheptane, octane, isooctane, etc.); petroleum ether; halogenated hydrocarbons (methyl chloride, methylene chloride, dichloroethane, dichloroethylene, trichloroethane, trichloroethylene, trichlorofluoromethane, perfluorinated hydrocarbons, etc.); and so forth, as well as mixtures thereof. Particularly suitable propellants are pentane and isobutane. The propellant is typically present in an amount of from about 1 wt. % to about 12 wt. %, in some embodiments from about 2 wt. % to about 10 wt. %, and in some embodiments, from about 3 wt. % to about 8 wt. % of the beads. Likewise, the polymer shell is typically present in an amount of from about 88 wt. % to about 99 wt. %, in some embodiments from about 90 wt. % to about 98 wt. %, and in some embodiments, from about 92 wt. % to about 97 wt. % of the beads.

### II. Composite Matrix

A. Synthetic Fibers

The synthetic fibers employed in the composite matrix may be formed from a variety of different thermoplastic polymers as is known in the art, such as polyolefins (e.g., ethylene polymers, propylene polymers, polybutylene, etc.); polytetrafluoroethylene; polyesters (e.g., polyethylene terephthalate, polylactic acid, etc.); polyvinyl acetate; polyvinyl chloride acetate; polyvinyl butyral; acrylic resins (e.g., polyacrylate, polymethylacrylate, etc.); polyamides, (e.g., nylon); polyvinyl chloride; polyvinylidene chloride; polystyrene; polyvinyl alcohol; polyurethanes; and so forth, as well as mixtures of various polymers. Polyolefin fibers (e.g., propylene homopolymers and/or copolymers) are particularly suitable for use in the present invention. Because many synthetic thermoplastic fibers are inherently hydrophobic (i.e., non-wettable), such fibers may optionally be rendered more hydrophilic (i.e., wettable) by treatment with a surfactant solution before, during, and/or after web formation. Other known methods for increasing wettability may also be employed, such as described in U.S. Pat. No. 5,057,361 to Sayovitz, et al.

The synthetic fibers may be monocomponent or multicomponent. Monocomponent fibers are generally formed from a polymer or blend of polymers extruded from a single extruder. Multicomponent fibers are generally formed from two or more polymers (e.g., bicomponent fibers) extruded from separate extruders. The polymers may be arranged in substantially constantly positioned distinct zones across the cross-section of the fibers. The components may be arranged in any desired configuration, such as sheath-core, side-by-side, pie, island-in-the-sea, three island, bull's eye, or various other arrangements known in the art. Various methods for forming multicomponent fibers are described in U.S. Pat. No. 4,789,592 to Taniguchi et al. and U.S. Pat. No. 5,336,552 to Strack et al., U.S. Pat. No. 5,108,820 to Kaneko, et al., U.S. Pat. No. 4,795,668 to Kruege, et al., U.S. Pat. No. 5,382,400 to Pike, et al., U.S. Pat. No. 5,336,552 to Strack, et al., and U.S. Pat. No. 6,200,669 to Marmon, et al. Multicomponent fibers having various irregular shapes may also be formed, such as described in U.S. Pat. No. 5,277,976 to Hogle, et al., U.S. Pat. No. 5,162,074 to Hills, U.S. Pat. No. 5,466,410 to Hills, U.S. Pat. No. 5,069,970 to Largman, et al., and U.S. Pat. No. 5,057,368 to Largman, et al.

The synthetic fibers may be formed using a variety of known processes. For example, the fibers may include spunbond fibers, meltblown fibers, as well as a combination thereof. Meltblown fibers are particularly suitable. The melt flow rate of the thermoplastic composition used to form the fibers may be selected within a certain range to optimize the properties of the resulting fibers. The melt flow rate is the weight of a polymer (in grams) that may be forced through an extrusion rheometer orifice (0.0825-inch diameter) when subjected to a force of 2160 grams in 10 minutes at 230° C. Generally speaking, the melt flow rate is high enough to improve melt processability, but not so high as to adversely interfere with the ability of the beads to expand in the desired manner. Thus, in most embodiments of the present invention, the thermoplastic composition used to form the synthetic fibers has a melt flow rate of from about 100 to about 6000 grams per 10 minutes, in some embodiments from about 200 to about 3000 grams per 10 minutes, and in some embodiments, from about 300 to about 1500 grams per 10 minutes, measured in accordance with ASTM Test Method D1238-E at a load of 2160 grams at 230° C.

B. Absorbent Material

Any absorbent material may generally be employed in the coform nonwoven web, such as absorbent fibers, particles, etc. In one embodiment, the absorbent material includes fibers formed by a variety of pulping processes, such as kraft pulp, sulfite pulp, thermomechanical pulp, etc. The pulp fibers may include softwood fibers having an average fiber length of greater than 1 mm and particularly from about 2 to 5 mm based on a length-weighted average. Such softwood fibers can include, but are not limited to, northern softwood, southern softwood, redwood, red cedar, hemlock, pine (e.g., southern pines), spruce (e.g., black spruce), combinations thereof, and so forth. Exemplary commercially available pulp fibers suitable for the present invention include those available from Weyerhaeuser Co. of Federal Way, Washington under the designation “Weyco CF-405.” Hardwood fibers, such as eucalyptus, maple, birch, aspen, and so forth, can also be used. In certain instances, eucalyptus fibers may be particularly desired to increase the softness of the web. Eucalyptus fibers can also enhance the brightness, increase the opacity, and change the pore structure of the web to increase its wicking ability. Moreover, if desired, secondary fibers obtained from recycled materials may be used, such as fiber pulp from sources such as, for example, newsprint, reclaimed paperboard, and office waste. Further, other natural fibers can also be used in the present invention, such as abaca, sabai grass, milkweed floss, pineapple leaf, and so forth. In addition, in some instances, synthetic fibers can also be utilized.

Besides or in conjunction with pulp fibers, the absorbent material may also include a superabsorbent that is in the form fibers, particles, gels, etc. Generally speaking, superabsorbents are water-swellable materials capable of absorbing at least about 20 times its weight and, in some cases, at least about 30 times its weight in an aqueous solution containing 0.9 weight percent sodium chloride. The superabsorbent may be formed from natural, synthetic and modified natural polymers and materials. Examples of synthetic superabsorbent polymers include the alkali metal and ammonium salts of poly(acrylic acid) and poly(methacrylic acid), poly(acrylamides), poly(vinyl ethers), maleic anhydride copolymers with vinyl ethers and alpha-olefins, poly(vinyl pyrrolidone), poly(vinylmorpholinone), poly(vinyl alcohol), and mixtures and copolymers thereof. Further, superabsorbents include natural and modified natural polymers, such as hydrolyzed acrylonitrile-grafted starch, acrylic acid grafted starch, methyl cellulose, chitosan, carboxymethyl cellulose, hydroxypropyl cellulose, and the natural gums, such as alginates, xanthan gum, locust bean gum and so forth. Mixtures of natural and wholly or partially synthetic superabsorbent polymers may also be useful in the present invention. Particularly suitable superabsorbent polymers are HYSORB 8800AD (BASF of Charlotte, N.C. and FAVOR SXM 9300 (available from Degussa Superabsorber of Greensboro, N.C.).

The absorbent material typically constitutes from about 20 wt. % to about 95 wt. %, in some embodiments from 40 wt. % to about 90 wt. %, and in some embodiments, from about 60 wt. % to about 85 wt. % of the composite matrix. Likewise, the synthetic fibers may constitute from about 1 wt. % to about 70 wt. %, in some embodiments from 4 wt. % to about 60 wt. %, and in some embodiments, from about 5 wt. % to about 50 wt. % of the composite matrix.

The manner in which the expandable beads are incorporated into the composite matrix of the coform nonwoven web may vary as desired. In certain embodiments, for example, the expandable beads may be incorporated into the matrix after the web is formed, such as by impregnation, saturation coating, etc. More desirably, however, the expandable beads are incorporated the matrix during formation of the coform web to ensure that they become distributed throughout the web in a substantially homogeneous manner. For instance, the beads may be added to a stream of the synthetic fibers and/or absorbent material as they are being formed or combined together.

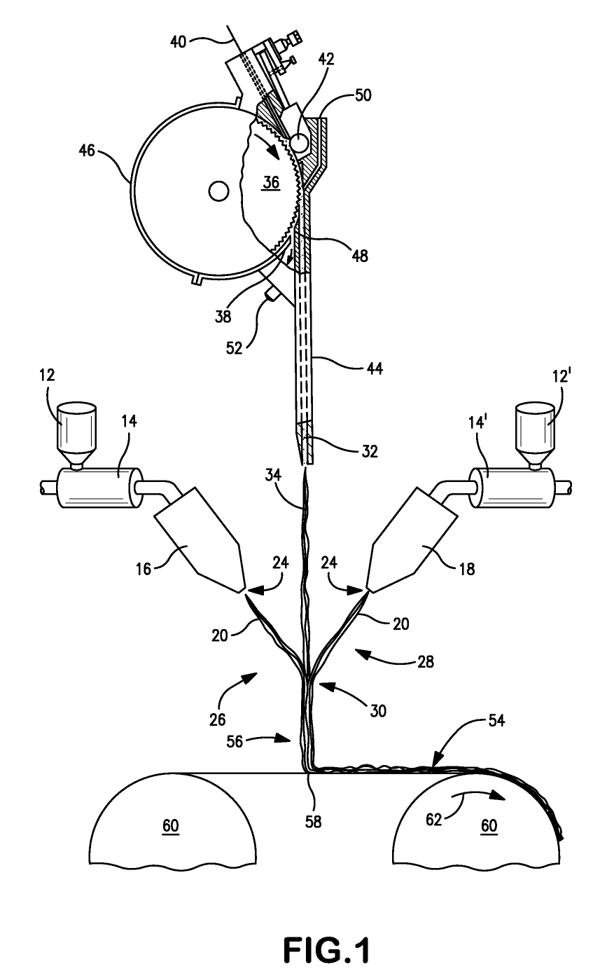

Referring to FIG. 1, for example, one embodiment of an apparatus is shown that can be used to form the coform web of the present invention. Generally speaking, the apparatus employs at one meltblown die head (e.g., two) that is arranged near a chute through which the absorbent material is added while the web forms. More particularly, in the illustrated embodiment, the apparatus includes a pellet hopper 12 or 12′ of an extruder 14 or 14′, respectively, into which a thermoplastic composition may be introduced to form the synthetic fibers of the web. The extruders 14 and 14′ each have an extrusion screw (not shown), which is driven by a conventional drive motor (not shown). As the thermoplastic composition advances through the extruders 14 and 14′, it is progressively heated to a molten state due to rotation of the extrusion screw by the drive motor. Heating may be accomplished in a plurality of discrete steps with its temperature being gradually elevated as it advances through discrete heating zones of the extruders 14 and 14′ toward two meltblowing dies 16 and 18, respectively. The meltblowing dies 16 and 18 may be yet another heating zone where the temperature of the thermoplastic composition is maintained at an elevated level for extrusion. If desired, the expandable beads of the present invention may be blended with the thermoplastic composition within one or both of the extruders 14 or 14′.

When two or more meltblowing die heads are used, such as described above, it should be understood that the fibers produced from the individual die heads may be different types of fibers. That is, one or more of the size, shape, or polymeric composition may differ, and furthermore the fibers may be monocomponent or multicomponent fibers. For example, larger fibers may be produced by the first meltblowing die head, such as those having an average diameter of about 10 micrometers or more, in some embodiments about 15 micrometers or more, and in some embodiments, from about 20 to about 50 micrometers, while smaller fibers may be produced by the second die head, such as those having an average diameter of about 10 micrometers or less, in some embodiments about 7 micrometers or less, and in some embodiments, from about 2 to about 6 micrometers. In addition, it may be desirable that each die head extrude approximately the same amount of polymer such that the relative percentage of the basis weight of the coform nonwoven web material resulting from each meltblowing die head is substantially the same. Alternatively, it may also be desirable to have the relative basis weight production skewed, such that one die head or the other is responsible for the majority of the coform web in terms of basis weight. As a specific example, for a meltblown fibrous nonwoven web material having a basis weight of 1.0 ounces per square yard or “osy” (34 grams per square meter or “gsm”), it may be desirable for the first meltblowing die head to produce about 30 percent of the basis weight of the meltblown fibrous nonwoven web material, while one or more subsequent meltblowing die heads produce the remainder 70 percent of the basis weight of the meltblown fibrous nonwoven web material. Generally speaking, the overall basis weight of the coform nonwoven web is from about 10 gsm to about 350 gsm, and more particularly from about 17 gsm to about 200 gsm, and still more particularly from about 25 gsm to about 150 gsm.

Each meltblowing die 16 and 18 is configured so that two streams of attenuating gas per die converge to form a single stream of gas which entrains and attenuates molten threads 20 as they exit small holes or orifices 24 in each meltblowing die. If desired, the expandable beads of the present invention may be combined with the molten threads 20.

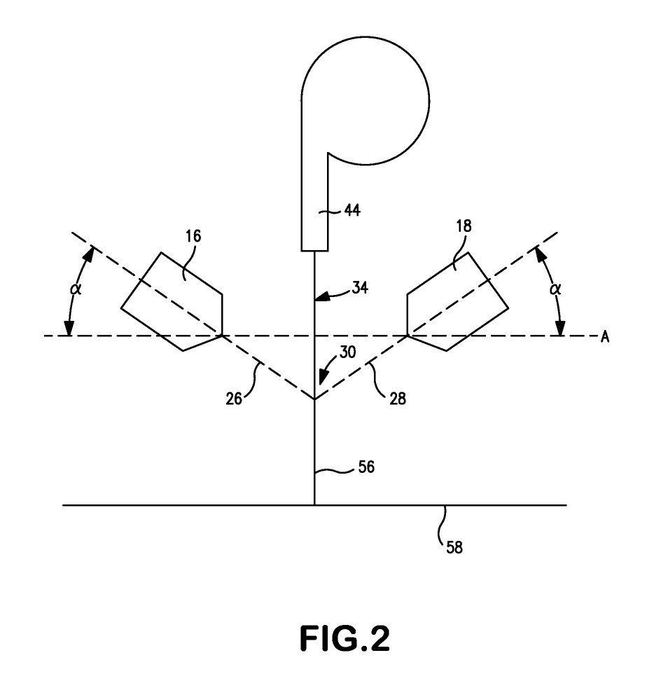

The molten threads 20 are formed into fibers or, depending upon the degree of attenuation, microfibers, of a small diameter which is usually less than the diameter of the orifices 24. Thus, each meltblowing die 16 and 18 has a corresponding single stream of gas 26 and 28 containing entrained thermoplastic polymer fibers. The gas streams 26 and 28 containing polymer fibers are aligned to converge at an impingement zone 30. Typically, the meltblowing die heads 16 and 18 are arranged at a certain angle with respect to the forming surface, such as described in U.S. Pat. Nos. 5,508,102 and 5,350,624 to Georger et al. Referring to FIG. 2, for example, the meltblown dies 16 and 18 may be oriented at an angle α as measured from a plane “A” tangent to the two dies 16 and 18. As shown, the plane “A” is generally parallel to the forming surface 58 (FIG. 1). Typically, each die 16 and 18 is set at an angle ranging from about 30 to about 75 degrees, in some embodiments from about 35° to about 60°, and in some embodiments from about 45° to about 55°. The dies 16 and 18 may be oriented at the same or different angles. In fact, the texture of the coform web may actually be enhanced by orienting one die at an angle different than another die.

Referring again to FIG. 1, an absorbent material 32 (e.g., pulp fibers) is also added to the two streams 26 and 28 of thermoplastic polymer fibers 20 and at the impingement zone 30. If desired, the expandable beads of the present invention may be blended with the absorbent material 32 either before or after formation of the streams 26 and 28. Introduction of the absorbent material 32 and any optional beads into the two streams 26 and 28 of thermoplastic polymer fibers 20 is desirably gradual in nature. This may be accomplished by merging a secondary gas stream 34 containing the absorbent material 32 between the two streams 26 and 28 of thermoplastic polymer fibers 20 so that all three gas streams converge in a controlled manner. Because they remain relatively tacky and semi-molten after formation, the meltblown fibers 20 may simultaneously adhere and entangle with the absorbent material 32 upon contact therewith to form a coherent nonwoven structure. Once again, the expandable beads of the present invention may also be incorporated into the secondary gas stream 34 if so desired.

Any conventional equipment may be employed to supply the absorbent material. In the illustrated embodiment, for instance, a picker roll 36 arrangement is provided that has a plurality of teeth 38 adapted to separate a mat or batt 40 of the absorbent material into individual fibers. When employed, the sheets or mats 40 are fed to the picker roll 36 by a roller arrangement 42. If desired, the expandable beads may be added to the picker roll 36 at this stage. After the teeth 38 of the picker roll 36 has separated the mat into separate fibers, they are conveyed toward the stream of thermoplastic polymer fibers through a nozzle 44. A housing 46 encloses the picker roll 36 and provides a passageway or gap 48 between the housing 46 and the surface of the teeth 38 of the picker roll 36. A gas, for example, air, is supplied to the passageway or gap 46 between the surface of the picker roll 36 and the housing 48 by way of a gas duct 50. The gas duct 50 may enter the passageway or gap 46 at the junction 52 of the nozzle 44 and the gap 48. The gas is supplied in sufficient quantity to serve as a medium for conveying the absorbent material 32 through the nozzle 44. The gas supplied from the duct 50 also serves as an aid in removing any remaining absorbent material 32 from the teeth 38 of the picker roll 36. The gas may be supplied by any conventional arrangement such as, for example, an air blower (not shown). As noted above, it is contemplated that the expandable beads may be optionally added to or entrained in the gas stream. If desired, the gas stream may also be heated to allow at least some expansion of the beads during formation of the web.

The absorbent material 32 is typically conveyed through the nozzle 44 at about the velocity at which the absorbent material 32 leaves the teeth 38 of the picker roll 36. In other words, the absorbent material 32, upon leaving the teeth 38 of the picker roll 36 and entering the nozzle 44, generally maintains its velocity in both magnitude and direction from the point where they left the teeth 38 of the picker roll 36. Such an arrangement, which is discussed in more detail in U.S. Pat. No. 4,100,324 to Anderson, et al.

If desired, the velocity of the secondary gas stream 34 may be adjusted to achieve coform structures of different properties. For example, when the velocity of the secondary gas stream is adjusted so that it is greater than the velocity of each stream 26 and 28 of thermoplastic polymer fibers 20 upon contact at the impingement zone 30, the absorbent material 32 and the optional expandable beads may be incorporated in the coform nonwoven web in a gradient structure. That is, the absorbent material 32 and/or expandable beads may have a higher concentration between the outer surfaces of the coform nonwoven web than at the outer surfaces. On the other hand, when the velocity of the secondary gas stream 34 is less than the velocity of each stream 26 and 28 of thermoplastic polymer fibers 20 upon contact at the impingement zone 30, the absorbent material 32 and/or expandable beads may be incorporated in the coform nonwoven web in a substantially homogenous fashion. That is, the concentration of the absorbent material and/or beads may be substantially the same throughout the coform nonwoven web. This is because the low-speed stream of absorbent material is drawn into a high-speed stream of thermoplastic polymer fibers to enhance turbulent mixing, which results in a consistent distribution of the material.

To convert the composite stream 56 of thermoplastic polymer fibers, absorbent material, and expandable beads into a coform nonwoven structure 54, a collecting device may be located in the path of the composite stream 56. The collecting device may be a forming surface 58 (e.g., belt, drum, wire, fabric, etc.) driven by rollers 60 and that is rotating as indicated by the arrow 62 in FIG. 1. The merged streams of thermoplastic polymer fibers, absorbent material, and expandable beads are collected as a coherent matrix of fibers on the surface of the forming surface 58 to form the coform nonwoven web 54. If desired, a vacuum box (not shown) may be employed to assist in drawing the near molten meltblown fibers onto the forming surface 58. The resulting textured coform structure 54 is coherent and may be removed from the forming surface 58 as a self-supporting nonwoven material.

It should be understood that the present invention is by no means limited to the above-described embodiments. In an alternative embodiment, for example, first and second meltblowing die heads may be employed that extend substantially across a forming surface in a direction that is substantially transverse to the direction of movement of the forming surface. The die heads may likewise be arranged in a substantially vertical disposition, i.e., perpendicular to the forming surface, so that the thus-produced meltblown fibers are blown directly down onto the forming surface. Such a configuration is well known in the art and described in more detail in, for instance, U.S. Patent Application Publication No. 2007/0049153 to Dunbar, et al. Multiple meltblowing die heads may also be used to produce fibers of differing sizes, a single die head may also be employed. An example of such a process is described, for instance, in U.S. Patent Application Publication No. 2005/0136781 to Lassig, et al.

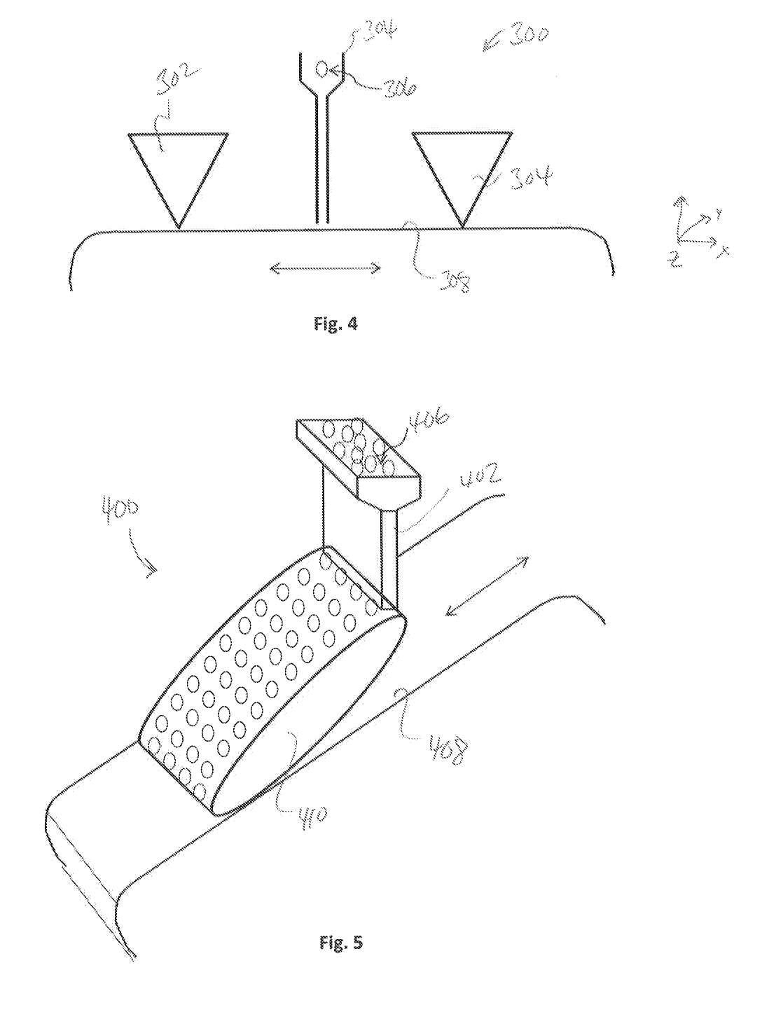

Furthermore, in the embodiments described above, the expandable beads are incorporated into the streams of synthetic fibers and/or absorbent material as the coform web is being formed. Using this approach, the beads can become randomly distributed in all directions (−x, −y, and −z directions). Of course, other techniques may also be employed. In one embodiment, for example, the beads can be added in a separate stream as the synthetic fibers and absorbent material are being formed or combined together. One example of such an embodiment is shown in FIG. 4. In FIG. 4, for instance, a coform apparatus 300 is shown that includes a first bank 302 for supplying the synthetic fibers and a second bank 304 for supplying the absorbent material to a forming surface 308. Expandable beads 306 are likewise supplied to the forming surface 308 via a third bank 304, which is positioned between the first and second banks. In such an embodiment, the positioning of the beads 306 in the −z direction (vertical) can be better controlled. In yet another embodiment, the beads may also be supplied to the forming surface in a predefined path. Referring to FIG. 5, for instance, a coform apparatus 400 is shown that includes a first bank 402 for supplying expandable beads 406 to a forming surface 408. In this embodiment, the beads 406 may be held in place by vacuum via a perforated drum 410 and then later discharged to the web path in a predefined pattern Rather than a vacuum, a static charge may also be employed to hold the beads 406 in place.

### III. Thermal Expansion

As explained above, the beads can be heated to a certain temperature to initiate the desired degree of expansion. Heating can occur, for instance, at a temperature of from about 30° C. to about 230° C., in some embodiments from about 60° C. to about 220° C., and in some embodiments, from about 100° C. to about 200° C. The manner and timing of such thermal expansion can vary depending on the particular application. In certain cases, for instance, it may be desired to thermally expand the beads before the coform nonwoven is converted into a product, such as wipe. In other cases, however, it may be desirable to delay expansion of until the product is formed. In this manner, the less bulky, pre-expanded nonwoven web can be more readily transported and processed into the product. After the product is formed, it may be heated to the desired temperature range so that the beads expand and the coform web achieves the desired degree of bulk. Of course, as noted above, the beads can be at least partially expanded during formation of the web, such as by heating the gas stream to which the beads are incorporated.

Regardless of the particular method employed, the resulting coform web may have a bulky feel and textured surface due to the expansion of the beads. Depending on the manner in which the beads are distributed, the texture may be substantially uniform or it may vary in a patterned configuration across a surface of the web. In most embodiments, for instance, the beads are spaced apart within the composite matrix and thus create a patterned surface texture on the web that has the appearance of peaks or tufts. These peaks may project from the surface of the web by about 0.25 millimeters to about 10 millimeters, and in some embodiments, from about 0.5 millimeters to about 5 millimeters. Because the peaks are created by the expanded beads, the surface thus has a desirable resiliency useful for wiping and scrubbing. The shape of the beads can influence the size and shape of the peaks. For instance, spherical beads may give spherical expanded peaks, while elongated, rod-like beads can be used to generate rod-like peak shapes.

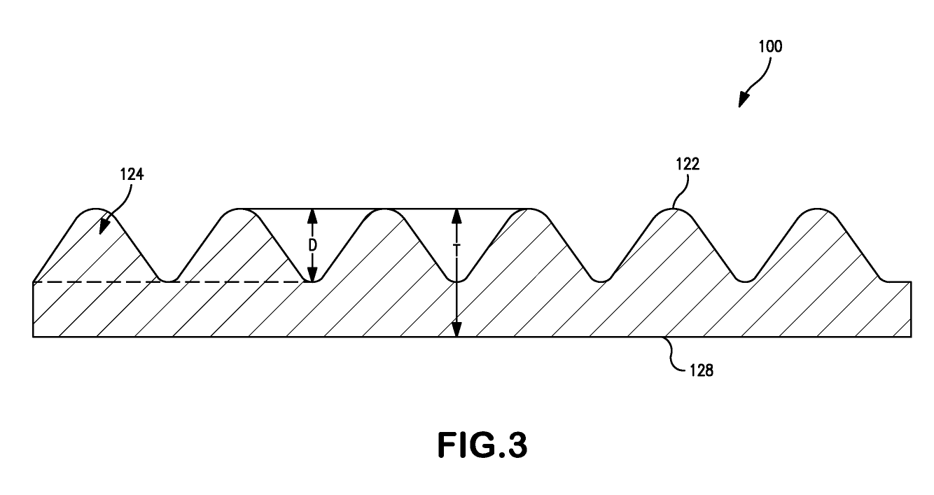

Referring to FIG. 3, for instance, a cross section of a bulky, textured coform web 100 having a first exterior surface 122 and a second exterior surface 128 is shown. In this embodiment, the first exterior surface 122 has a three-dimensional surface texture that includes peaks 124 extending upwardly from the plane of the coform material. One indication of the magnitude of three-dimensionality in the textured exterior surface(s) of the coform web is the peak to valley ratio, which is calculated as the ratio of the overall caliper “T” divided by the valley depth “D.” When formed in accordance with the present invention, the coform web typically has a peak to valley ratio of about 1.1 to about 10, in some embodiments from about 1.5 to about 6, and in some embodiments, from about 2 to about 4. The number and arrangement of the peaks 24 may vary widely depending on the desired end use. Generally, the textured coform web will have from about 0.05 and about 50 peaks per square centimeter, and in some embodiments, from about 1 and 20 peaks per square centimeter. The coform web may also exhibit a three-dimensional texture on the second surface of the web. In this case, the valley depth D is measured for both exterior surfaces as above and are then added together to determine an overall material valley depth.

### IV. Articles

The coform nonwoven web may be used in a wide variety of articles. For example, the web may be incorporated into an “absorbent article” that is capable of absorbing water or other fluids. Examples of some absorbent articles include, but are not limited to, personal care absorbent articles, such as diapers, training pants, absorbent underpants, incontinence articles, feminine hygiene products (e.g., sanitary napkins), swim wear, baby wipes, mitt wipe, and so forth; medical absorbent articles, such as garments, fenestration materials, underpads, bedpads, bandages, absorbent drapes, and medical wipes; food service wipers; clothing articles; pouches, and so forth. Materials and processes suitable for forming such articles are well known to those skilled in the art.

In one particular embodiment of the present invention, the coform web is used to form a wipe. The wipe may be formed entirely from the coform web or it may contain other materials, such as films, nonwoven webs (e.g., spunbond webs, meltblown webs, carded web materials, other coform webs, airlaid webs, etc.), paper products, and so forth. In one embodiment, for example, two layers of a textured coform web may be laminated together to form the wipe, such as described in U.S. Patent Application Publication No. 2007/0065643 to Kopacz. In such embodiments, one or both of the layers may be formed from the coform web of the present invention. In another embodiment, it may be desired to provide a certain amount of separation between a user's hands and a moistening or saturating liquid that has been applied to the wipe, or, where the wipe is provided as a dry wiper, to provide separation between the user's hands and a liquid spill that is being cleaned up by the user. In such cases, an additional nonwoven web or film may be laminated a surface of the coform web to provide physical separation and/or provide liquid barrier properties. Other fibrous webs may also be included to increase absorbent capacity, either for the purposes of absorbing larger liquid spills, or for the purpose of providing a wipe a greater liquid capacity. When employed, such additional materials may be attached to the coform web using any method known to one skilled in the art, such as by thermal or adhesive lamination or bonding with the individual materials placed in face to face contacting relation. Regardless of the materials or processes utilized to form the wipe, the basis weight of the wipe is typically from about 20 to about 200 grams per square meter (gsm), and in some embodiments, between about 35 to about 100 gsm. Lower basis weight products may be particularly well suited for use as light duty wipes, while higher basis weight products may be better adapted for use as industrial wipes.

The wipe may assume a variety of shapes, including but not limited to, generally circular, oval, square, rectangular, or irregularly shaped. Each individual wipe may be arranged in a folded configuration and stacked one on top of the other to provide a stack of wet wipes. Such folded configurations are well known to those skilled in the art and include c-folded, z-folded, quarter-folded configurations and so forth. For example, the wipe may have an unfolded length of from about 2.0 to about 80.0 centimeters, and in some embodiments, from about 10.0 to about 25.0 centimeters. The wipes may likewise have an unfolded width of from about 2.0 to about 80.0 centimeters, and in some embodiments, from about 10.0 to about 25.0 centimeters. The stack of folded wipes may be placed in the interior of a container, such as a plastic tub, to provide a package of wipes for eventual sale to the consumer. Alternatively, the wipes may include a continuous strip of material which has perforations between each wipe and which may be arranged in a stack or wound into a roll for dispensing. Various suitable dispensers, containers, and systems for delivering wipes are described in U.S. Pat. No. 5,785,179 to Buczwinski, et al.; U.S. Pat. No. 5,964,351 to Zander; U.S. Pat. No. 6,030,331 to Zander; U.S. Pat. No. 6,158,614 to Haynes, et al.; U.S. Pat. No. 6,269,969 to Huang, et al.; U.S. Pat. No. 6,269,970 to Huang, et al.; and U.S. Pat. No. 6,273,359 to Newman, et al.

In certain embodiments of the present invention, the wipe is a “wet” or “premoistened” wipe in that it contains a liquid solution for cleaning, disinfecting, sanitizing, etc. The particular liquid solutions are not critical and are described in more detail in U.S. Pat. No. 6,440,437 to Krzysik, et al.; U.S. Pat. No. 6,028,018 to Amundson, et al.; U.S. Pat. No. 5,888,524 to Cole; U.S. Pat. No. 5,667,635 to Win, et al.; and U.S. Pat. No. 5,540,332 to Kopacz, et al. The amount of the liquid solution employed may depending upon the type of wipe material utilized, the type of container used to store the wipes, the nature of the cleaning formulation, and the desired end use of the wipes. Generally, each wipe contains from about 100 wt. % to about 600 wt. %, in some embodiments from about 200 wt. % to about 500 wt. %, and in some embodiments, from about 250 to about 500 wt. % of a liquid solution based on the dry weight of the wipe.

The present invention may be better understood with reference to the following examples.

### Test Methods

Caliper: The term “caliper” generally refers to the thickness of a sheet or web. Caliper can be measured using a sample size of 90 by 102 mm millimeters under a controlled loading pressure of approximately 0.345 kilopascal (kPa) [0.05 pound-force per square inch (psi)]. The thickness is determined as the distance between an anvil, or base, and a platen used to apply the specified pressure.

### Example 1

A coform web was made by fiberizing Golden Isles Fluff Pulp (GP Cellulose, LLC) in an arrangement similar to that described in FIG. 1. The pulp was fed at a rate of 29.8 g per cross sectional inch per min with an air flow rate of 9900 ft/min through a nozzle. A propylene homopolymer (Metocene™ MF650X, Equistar Chemicals, LP) was used to form meltblown fibers and introduced to the cellulose fibers at a 45° angle at a rate of 12.8 g per cross sectional inch per min with an air velocity of 34 ft/min from each meltblown head. Expandable polyethylene/styrenic beads (ARCEL™ ULV, Nova Chemicals) were fed to the pulp stream at the exit of pulp nozzle at a rate of 1.8 g per cross sectional inch per min. The resulting mixture of pulp/expandable beads/meltblown fiber was captured at a perforated forming surface moving at a speed of 73.5 ft/min, and the forming surface had a negative pressure to ensure capture of the material on the surface. This “unexpanded” coform web was then heated with steam at a temperature of 100° C. for 5 minutes to allow the beads to expand. One day later, the beads were further expanded with an additional steam heating for another 5 minutes. The expanded coform web was then passed through a nip point with a pressure of 5 pounds per linear inch.

The resulting web was tested under dry and wet conditions. Wet samples were made by adding an aqueous solution in an amount of 300% by weight of the coform web. The aqueous solution contained 99.2 wt. % of water and 0.8 wt. % of a surfactant. The dry and wet thickness values were then measured and are set forth in the table below.

| | Dry Thickness (mm) | Wet Thickness (mm) |
|---|---|---|
| Unexpanded Coform Web | 1.4 | 1.2 |
| Expanded Coform Web | 4.1 | 3.8 |

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A coform nonwoven web comprising a composite matrix formed from a combination of synthetic fibers and an absorbent material, wherein a plurality of beads are contained within the composite matrix that include a propellant encapsulated within a hollow thermoplastic polymer shell.

2. The coform nonwoven web of claim 1, wherein the bulk of the coform nonwoven web is about 10 cubic centimeters per gram or more and/or the caliper of the coform nonwoven web is about 0.1 centimeters or more.

3. The coform nonwoven web of claim 1, wherein the boiling point of the propellant at atmospheric pressure is from about −50° C. to about 100° C.

4. The coform nonwoven web of claim 3, wherein the propellant includes pentane, isobutane, or a combination thereof.

5. The coform nonwoven web of claim 1, wherein the shell is obtained by polymerizing a styrene monomer, olefin monomer, nitrile monomer, acrylic ester monomer, methacrylic ester monomer, vinyl halide monomer, vinyl ester monomer, diene monomer, or a combination thereof.

6. The coform nonwoven web of claim 1, wherein the synthetic fibers are meltblown fibers.

7. The coform nonwoven web of claim 6, wherein the meltblown fibers contain a polyolefin.

8. The coform nonwoven web of claim 1, wherein the absorbent material contains pulp fibers.

9. The coform nonwoven web of claim 1, wherein the synthetic fibers constitute from 1 wt. % to about 70 wt. % of the web and the absorbent material constitutes from about 20 wt. % to about 95 wt. % of the web.

10. The coform nonwoven web of claim 1, wherein the web defines an exterior surface having a three-dimensional texture that includes a plurality of peaks and valleys.

11. A wipe comprising the coform nonwoven web of claim 1.

12. The wipe of claim 11, wherein the wipe contains from about 150 to about 600 wt. % of a liquid solution based on the dry weight of the wipe.

13. The wipe of claim 12, wherein the coform nonwoven web has a caliper of about 0.1 centimeters or more.

14. A method of forming the coform nonwoven web of claim 1, the method comprising:
merging together a stream of the absorbent material with a stream of the synthetic fibers to form a composite stream; and
thereafter, collecting the composite stream on a forming surface to form the coform nonwoven web.

15. The method of claim 14, wherein the beads are contained within the stream of the absorbent material, the stream of the synthetic fibers, or both.

16. The method of claim 14, wherein the beads are applied between the stream of the absorbent material and the synthetic fibers.

17. The method of claim 14, wherein the beads are applied to the forming surface.

18. A method for forming a wipe, the method comprising:
providing a coform nonwoven web comprising a composite matrix formed from a combination of synthetic fibers and an absorbent material, wherein a plurality of expandable beads are contained within the composite matrix that contain a propellant; and
expanding the beads by heating the web to a temperature above the boiling point of the propellant.

19. The method of claim 18, wherein the beads expand to a size that is at least about 10 times the size of the expandable beads.

20. The method of claim 18, wherein the volume-average size of the beads after expansion is from about 0.5 to about 30 millimeters and wherein the volume-average size of the expandable beads prior to expansion is from about 0.1 to about 5 millimeters.

21. The method of claim 18, further comprising applying a liquid solution to the wipe prior to expanding the beads.
